(19) United States
(12) Patent Application Publication
(10) Pub. No.: US 2025/0138932 A1
(43) Pub. Date: May 1, 2025

(54) INFORMATION PROCESSING APPARATUS, INFORMATION PROCESSING METHOD, ARTICLE MANUFACTURING METHOD, PRINTER, PRINTER CONTROL METHOD, AND STORAGE MEDIUM

(71) Applicant: CANON KABUSHIKI KAISHA, Tokyo (JP)

(72) Inventor: HIROKI KANAI, Tokyo (JP)

(21) Appl. No.: 18/915,155

(22) Filed: Oct. 14, 2024

(30) Foreign Application Priority Data
Oct. 26, 2023 (JP) 2023-183965

(51) Int. Cl. G06F 11/07

(52) U.S. Cl. CPC G06F 11/079; G06F 11/0733

(57) ABSTRACT

An information processing apparatus acquires information about an apparatus that executes a predetermined process and assigns first information about success or failure of the execution of the predetermined process and second information about an execution timing of the predetermined process to data that changes depending on a state of the apparatus.

### BACKGROUND

### Field

The present disclosure relates to information processing and printers.

### Description of the Related Art

In recent years, various apparatuses have been introduced into factories to automate manufacturing. These apparatuses generate deliverables by executing a predetermined process, and there are instances where it is desirable to associate the behavior of the apparatus in this generation process with the quality of the deliverables. Doing so, for example, enables determining which behavior of the apparatus causes defects in the quality of the deliverables and to make improvements to the apparatus. Generally, the behavior in this generation process is often quantified by measuring vibration, noise, an electric current, or the like, which is a physical quantity generated by the apparatus during the generation process. To associate the quality of the processing results (deliverables) with the behavior during the process, it is necessary to associate the process executed by the apparatus to obtain the deliverables with measured data.

Japanese Patent Application Laid-Open No. 2001-12973 discusses a technique for associating a process executed by an apparatus with measured data. The inspection apparatus discussed in Japanese Patent Application Laid-Open No. 2001-12973 associates the inspection apparatus, an inspection process executed, and a measured data file with each other by assigning the apparatus identification number and the number of times data has been outputted to the file name of measured data for each inspection.

### SUMMARY

According to an aspect of the present disclosure, an information processing apparatus configured to acquire information about an apparatus that executes a predetermined process includes at least one memory storing at least one program, and at least one processor, that when executing the at least one program, causes the information processing apparatus to: assign first information about success or failure of the execution of the predetermined process, and assign second information about an execution timing of the predetermined process to data that changes depending on a state of the apparatus.

Further features of the present disclosure will become apparent from the following description of exemplary embodiments with reference to the attached drawings.

### BRIEF DESCRIPTION OF THE DRAWINGS

FIG. 1 is a control block diagram of an information processing apparatus according to a first exemplary embodiment.

FIG. 2 is a control block diagram of the information processing apparatus according to the first exemplary embodiment.

FIG. 3 illustrates a correspondence relationship among a process of a mechanical apparatus, deliverables of the mechanical apparatus, measured data, and file names according to the first exemplary embodiment.

FIG. 4 is a control flowchart according to the first exemplary embodiment.

FIG. 5 illustrates a correspondence relationship among a process of a mechanical apparatus, deliverables of the mechanical apparatus, measured data, and file names according to a second exemplary embodiment.

FIG. 6 is a control block diagram of an information processing apparatus according to the second exemplary embodiment.

FIG. 7 illustrates an example of a correspondence relationship among a process of a mechanical apparatus, deliverables of the mechanical apparatus, measured data, and file names according to a third exemplary embodiment.

FIG. 8 illustrates another example of a correspondence relationship among a process of a mechanical apparatus, deliverables of the mechanical apparatus, measured data, and file names according to the third exemplary embodiment.

FIG. 9 is a table in which information about sensor numbers and error determination thresholds according to a fourth exemplary embodiment is set.

FIG. 10 illustrates a correspondence between measured data and file names according to an example of the fourth exemplary embodiment.

FIG. 11 illustrates a correspondence between measured data and file names according to another example of the fourth exemplary embodiment.

### DESCRIPTION OF THE EMBODIMENTS

Hereinafter, exemplary embodiments of the present disclosure will be described with reference to attached drawings. The exemplary embodiments are merely examples, and the details of the configuration can be changed as appropriate by those skilled in the art without departing from the scope of the present disclosure. The numerical values used in the exemplary embodiments are reference values and are not seen to be limiting.

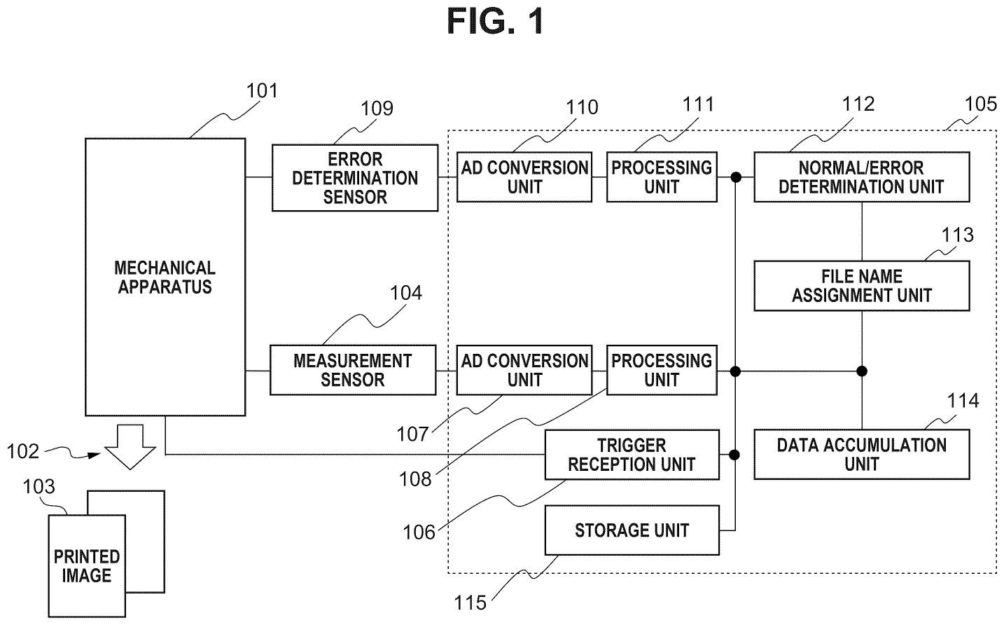

FIG. 1 is a schematic diagram illustrating an information processing apparatus 105 according to a first exemplary embodiment. The information processing apparatus 105 can accumulate measured data acquired by using sensors, etc. The information processing apparatus 105 includes a central processing unit (CPU), which is a hardware component for various functional blocks described below. The information processing apparatus 105 also includes a read-only memory (ROM) and a random access memory (RAM) as storage units. The information processing apparatus 105 includes a communication interface (hereinafter referred to as “I/F”) for communication with a mechanical apparatus 101 and external devices. If the information processing apparatus 105 acquires a large amount of data, the information processing apparatus 105 can include a hard disk drive (HDD).

The mechanical apparatus 101 is an apparatus that generates deliverables by executing a predetermined process. For example, a printer that generates images 103 by executing a printing process 102 is an example of the mechanical apparatus 101. While a printer is used as an example of the mechanical apparatus 101 in the present exemplary embodiment, the mechanical apparatus 101 is not limited to a printer. For example, the mechanical apparatus 101 can be a grinder or a polisher that processes materials to manufacture articles as deliverables, a molding machine that manufactures articles as deliverables by ejecting and molding materials, or a robot that manufactures articles as deliverables by assembling or disassembling materials. These devices execute a predetermined process to manufacture articles.

The mechanical apparatus 101 is connected to a measurement sensor 104 for monitoring the operating state of the printing process 102. For example, using an acceleration sensor as the measurement sensor 104 enables quantifying the acceleration generated by the vibration of a gear during the printing process. The measurement sensor 104 is also connected to the information processing apparatus 105, and the data measured by the measurement sensor 104 is processed and stored in the information processing apparatus 105. While an acceleration sensor is used as an example of the measurement sensor 104 in the present exemplary embodiment, the measurement sensor 104 is not limited to an acceleration sensor. Depending on the type of the monitoring target apparatus, any sensor that can acquire a predetermined physical quantity, such as a current sensor, a position sensor, a vibration sensor, a force sensor, a camera, a pressure sensor, a light sensor, a torque sensor, or a temperature sensor, can be used as the measurement sensor 104 as appropriate. The measurement sensor 104 can be referred to as a second sensor.

Measurement using the measurement sensor 104 is executed when a trigger reception unit 106 in the information processing apparatus 105 receives a measurement trigger, and the measurement is executed within a predetermined time based on the sampling frequency and the number of data points that are set in a processing unit 108. As the measurement trigger, for example, a printing start signal from the printer or an input signal generated when a person presses a switch can be used. The number of times the measurement trigger has been inputted is stored in a storage unit 115 as a cumulative number. Any one of various kinds of signals can be set as the measurement trigger, such as a signal for starting the predetermined process that causes the apparatus to produce a deliverable, a signal for detecting the end of the process, a signal that changes during the execution of the predetermined process, or detection of a physical quantity.

The input signal from the measurement sensor 104 is first converted from analog to digital by an analog-to-digital (AD) conversion unit 107, and then the obtained digital signal is converted into a file by the processing unit 108. The file format can be a text format, a comma-separated value (CSV) format, or a compressed version of any one of these formats. The file name is determined as described below.

Whether the printing process of the mechanical apparatus 101 has been executed normally is determined based on the measurement result of an error determination sensor 109. The signal input from the error determination sensor 109 to the information processing apparatus 105 is converted from analog to digital by an AD conversion unit 110. The obtained digital signal is next converted into feature amount per unit time by signal processing of a processing unit 111. Examples of the signal processing include an average value process, a maximum value process, a minimum value process, and a fast Fourier transform (FFT) process. The processing unit 111 can execute no process on the obtained digital signal. A normal/error determination unit 112 determines whether the process of the mechanical apparatus 101 has been executed normally by comparing the feature amount per unit time, which is the result of the signal processing, with a preset threshold. Examples of the error determination sensor 109 include an acceleration sensor, a current sensor, a position sensor, a vibration sensor, a force sensor, a camera, a pressure sensor, a light sensor, a torque sensor, or a temperature sensor. The error determination sensor 109 can be referred to as a first sensor.

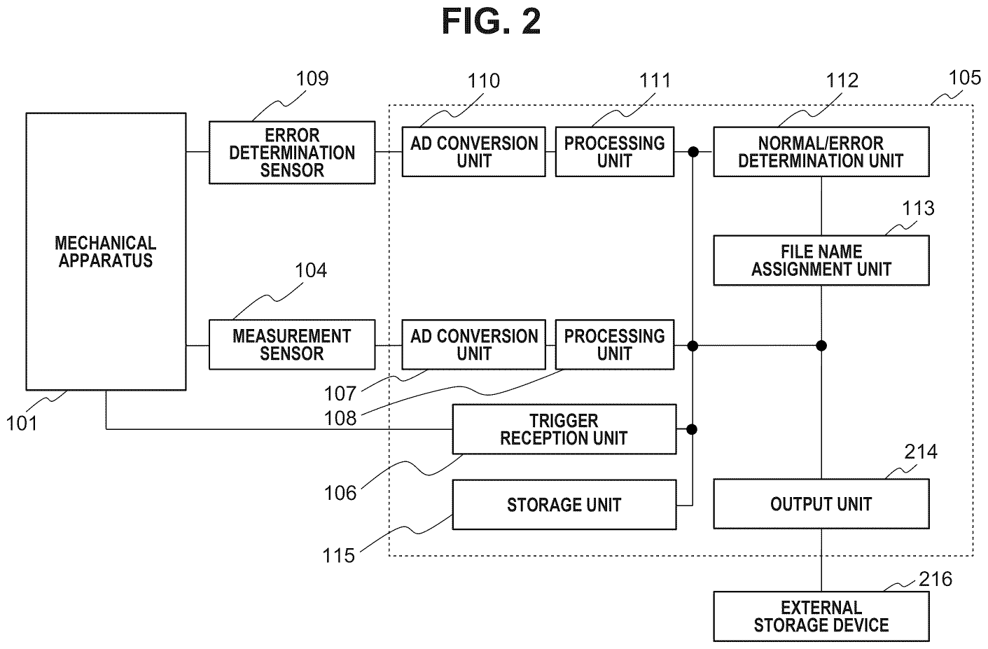

Based on this determination result, a file name assignment unit 113 assigns information regarding whether the process of the mechanical apparatus 101 has been executed normally, the cumulative number of triggers, the number of processes executed normally, and the number of processes interrupted due to an error to the file name of measured data, and stores the measured data in a data accumulation unit 114. In addition, as illustrated in FIG. 2, the data can be stored in an external storage device 216 via an output unit 214. The output unit 214 can execute wireless communication or wired communication. This data storage is executed by controlling the storage state of either the data accumulation unit 114 or the external storage device 216.

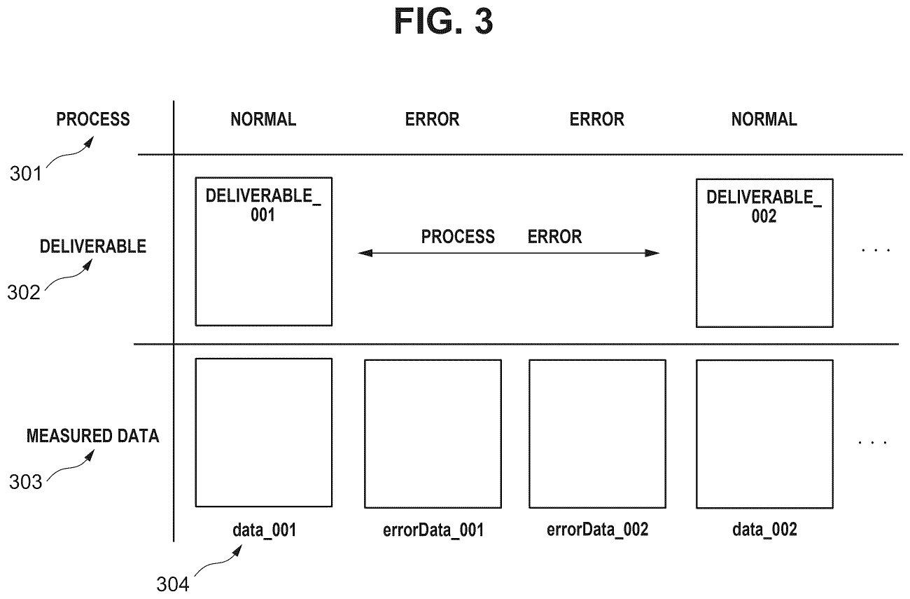

FIG. 3 illustrates an example of a correspondence relationship among the process of the mechanical apparatus, deliverables of the mechanical apparatus, measured data, and file names according to the present exemplary embodiment. A process 301 indicates whether the process of the mechanical apparatus 101 has been executed normally or whether the process has been interrupted due to an error. The example illustrated in FIG. 3 indicates that the mechanical apparatus 101 has executed the process four times and the four processes have resulted in normal, error, error, and normal in this order. These normal and error states are determined based on the error determination sensor 109.

A deliverable 302 illustrates a deliverable generated (acquired) by a corresponding process 301. Because the second and third processes have been interrupted due to an error during the respective processes, the generated deliverables are those generated by the first and fourth processes. Measured data 303 illustrates the data measured by the measurement sensor 104 at the execution of the respective processes. One file of measured data is generated per process.

A file name 304 is assigned to each piece of these measured data. The file name 304 includes information regarding whether the corresponding process has been executed normally, the cumulative number of normal processes, and the cumulative number of error processes. For example, in the first file name “data_001”, “data” indicates that the process has been executed normally, and “001” indicates the cumulative number of processes executed normally. In the second file name “errorData_001”, “errorData” indicates that the process has been interrupted due to an error and, and “001” indicates the cumulative number of processes interrupted due to an error. In the present exemplary embodiment, the execution timings of the processes are indicated by numbers such as “001” and “002”. However, the execution timings can be indicated in another way. For example, the execution timings can be indicated by using letters such as “A”, “B”, and “ZZZ”. The information regarding the success or failure of the process can be referred to as first information, and the information regarding the execution timing of the process can be referred to as second information.

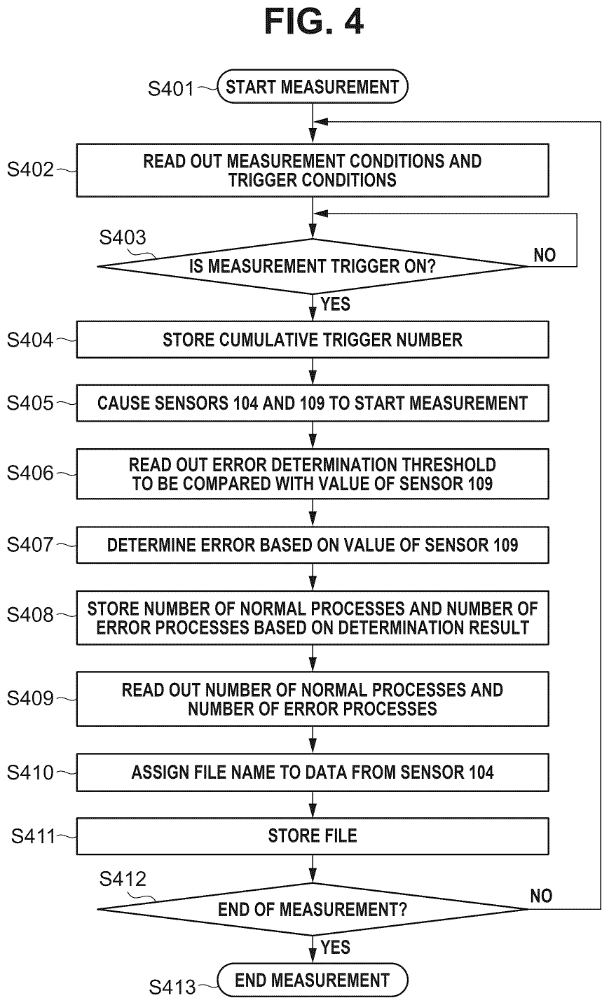

FIG. 4 is a control flowchart of the information processing apparatus 105 according to the present exemplary embodiment. In the present exemplary embodiment, the control flowchart illustrated in FIG. 4 is executed by various functional blocks of the information processing apparatus 105.

First, in step S401, the processing unit 111 and the processing unit 108 start to measure the state of the mechanical apparatus 101.

Next, in step S402, the processing unit 111 and the processing unit 108 read out the measurement conditions such as the sampling frequency and the number of data points, the measurement trigger conditions, the measurement end conditions, etc., which are stored in the storage unit 115, from the storage unit 115, and the trigger reception unit 106 waits for a measurement trigger.

Next, in step S403, if a measurement trigger is ON (YES in step S403), the operation proceeds to step S404. In step S404, the processing unit 108 stores the cumulative number of times the trigger has been turned ON in the storage unit 115. The processing unit 111 can store this cumulative number in the storage unit 115. The cumulative number of times the trigger has been turned ON is the number of times the mechanical apparatus 101 has executed the process as described above. In step S403, if the measurement trigger is in an OFF-state (NO in step $403), the trigger reception unit 106 continues to wait for a measurement trigger.

In step S405, the processing units 108 and 111 cause the measurement sensor 104 and the error determination sensor 109 to start measurement, and the analog input signals from these sensors are converted into digital signals by the AD conversion units 107 and 110. Next, the processing unit 108 converts the measured data transmitted from the measurement sensor 104 into a file, and stores the created file in the storage unit 115. The processing unit 111 executes signal processing on the value transmitted from the error determination sensor 109 to convert the value into feature amounts, and stores the obtained feature amounts in the storage unit 115.

Next, in step S406, the normal/error determination unit 112 reads out a threshold from the storage unit 115. The threshold is used for determining whether the process of the mechanical apparatus 101 has been executed normally, based on the value from the error determination sensor 109.

Next, in step S407, the normal/error determination unit 112 determines whether the process of the mechanical apparatus 101 has been executed normally, based on the threshold read out from the storage unit 115 and the value of the error determination sensor 109.

Next, in step S408, the normal/error determination unit 112 stores the number of processes executed normally or the number of processes interrupted due to an error in the storage unit 115, based on the determination result of whether the process of the mechanical apparatus 101 has been executed normally.

Next, in step S409, the file name assignment unit 113 reads out the number of processes normally executed or the number of processes interrupted due to an error from the storage unit 115, based on the determination result of whether the process of the mechanical apparatus 101 has been executed normally.

Next, in step S410, the file name assignment unit 113 reads out the measured data obtained by the measurement sensor 104 from the storage unit 115, and assigns a file name by combining the determination result in step S407 and the number of times read out in step S409.

Next, in step S411, the file name assignment unit 113 stores the measured data obtained by the measurement sensor 104 in the data accumulation unit 114, the assigned file name of the measured data being a combination of the determination result of whether the process of the mechanical apparatus 101 has been executed normally and the number of times read out in step S409.

Next, in step S412, the processing units 111 and 108 determine whether the conditions for ending the measurement of the state of the mechanical apparatus 101 are satisfied. If the conditions for ending the measurement are not satisfied (NO in step S412), the processing returns to step S402 and the measurement of the state of the mechanical apparatus 101 continues. If the conditions are satisfied (YES in step S412), the operation proceeds to step S413 and the measurement of the state of the mechanical apparatus 101 ends.

According to the present exemplary embodiment, the measured data from the measurement sensor 104, the measured data being information about the state of the mechanical apparatus 101, is assigned information regarding whether the process of the mechanical apparatus 101 has been executed normally and information about the number of processes executed. In addition, regarding the number of processes executed, the number of processes executed normally and the number of processes interrupted are counted and assigned separately. This enables associating a processing result with corresponding measured data. Therefore, it is possible to properly distinguish data measured during a normally executed process from data obtained when the process has not been executed or has been interrupted. As a result, it is possible to properly associate information about the measured data of the apparatus with information about the process of the apparatus. That is, it is possible to reduce the occurrence of problems in data analysis work and carry out appropriate data processing.

In the above-described first exemplary embodiment, the file name of each piece of the measured data is assigned information regarding whether the process of the mechanical apparatus 101 has been executed normally and information about the execution timing of the process. In addition to the information regarding whether the process of the mechanical apparatus 101 has been executed normally and the information about the execution timing, identification information such as an individual number unique to the mechanical apparatus 101 and/or an individual number unique to the information processing apparatus 105 can be added.

A second exemplary embodiment will now be described. The same reference characters will be used for the components that are the same as or equivalent to those in the above-described first exemplary embodiment, and the description of these same or equivalent components will be omitted or simplified. That is, the following description will focus on the aspects of the second exemplary embodiment that differ from the above-described first exemplary embodiment.

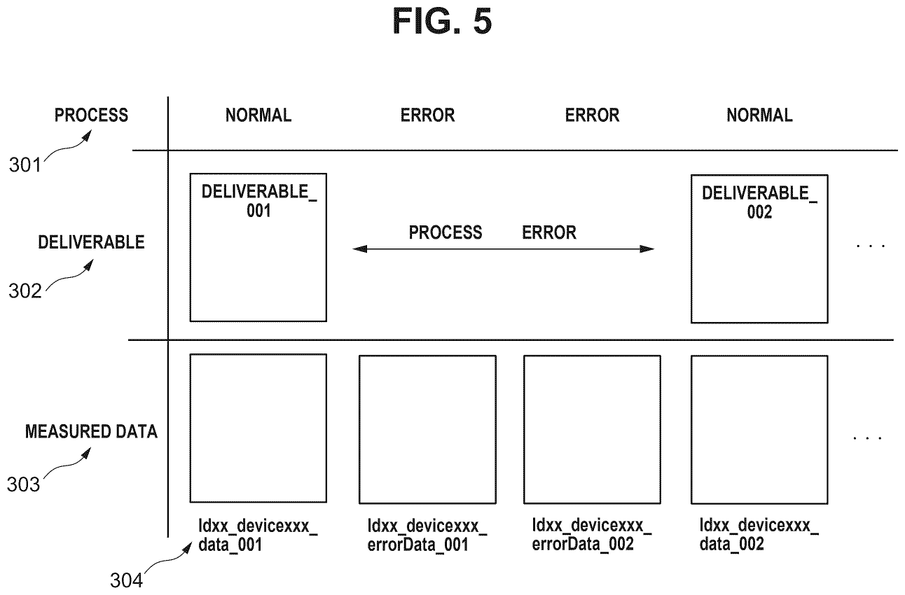

FIG. 5 illustrates a correspondence relationship among the process of the mechanical apparatus 101, deliverables of the mechanical apparatus 101, measured data, and file names according to the second exemplary embodiment. A process 301 indicates whether the process of the mechanical apparatus 101 has been executed normally or whether the process has been interrupted due to an error. The example illustrated in FIG. 5 indicates that the mechanical apparatus 101 has executed the process four times and the four processes have resulted in normal, error, error, and normal in this order.

A deliverable 302 illustrates a deliverable generated (acquired) by a corresponding process 301. Because the second and third processes have been interrupted due to an error during their respective processes, the generated deliverables are those generated by the first and fourth processes. Measured data 303 illustrates the data measured by the measurement sensor 104 at the execution of their respective processes. One file of measured data is generated for each process.

A file name 304 is assigned to each piece of the measured data. The file name 304 includes information regarding whether a corresponding process has been executed normally, the cumulative number of normal processes, the cumulative number of error processes, an ID unique to the mechanical apparatus 101, and an ID unique to the information processing apparatus 105. For example, the “Idxx” in the first file name “Idxx_devicexx_data_001” indicates the unique ID that is set for the mechanical apparatus 101. “devicexxx” indicates a unique ID that is set for the information processing apparatus 105. “data”, “error data”, and “001” are the same as those in the above-described first exemplary embodiment. While the ID unique to the mechanical apparatus 101 and the ID unique to the information processing apparatus 105 are assigned to the measured data in the present exemplary embodiment, only one of them can be assigned to the measured data.

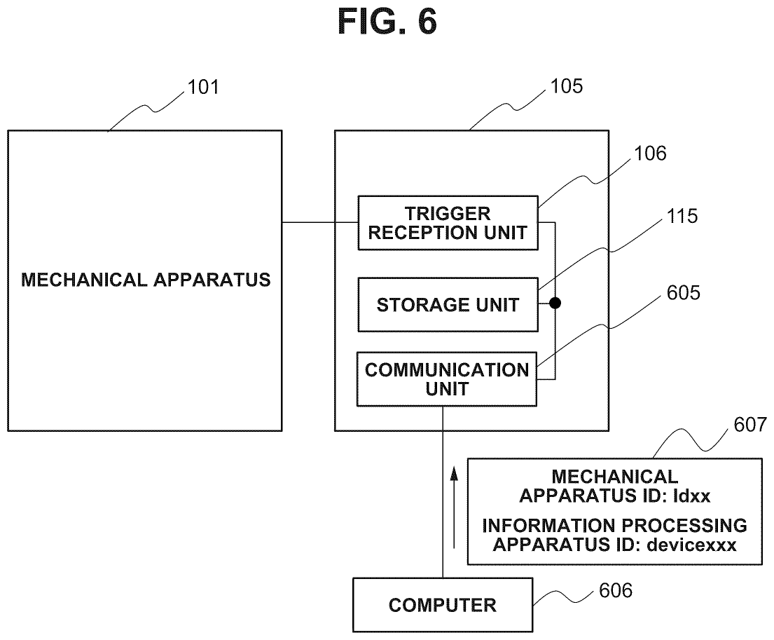

FIG. 6 is a control block diagram of the information processing apparatus 105 according to the present exemplary embodiment. The process of assigning the ID of the mechanical apparatus 101 and the ID of the information processing apparatus 105 to a file name will be described with reference to FIG. 6.

As illustrated in FIG. 6, before measurement, the information processing apparatus 105 is connected to an external computer 606 via a communication unit 605. The information processing apparatus 105 acquires information about individual numbers 607 from the external computer 606. This information indicates the preset individual number of the information processing apparatus 105 and an individual number of the mechanical apparatus 101, and is stored in the storage unit 115 of the information processing apparatus 105. The individual number of the information processing apparatus 105 and the individual number of the mechanical apparatus 101 to be measured by the information processing apparatus 105 can be stored in advance in the storage unit 115 of the information processing apparatus 105. If an individual number is set for the mechanical apparatus 101, the trigger reception unit 106 can acquire the individual number from the mechanical apparatus 101 at the same timing as the reception timing of a measurement trigger. The information processing apparatus 105 can be configured to acquire information other than the above-described individual numbers. For example, the information processing apparatus 105 can acquire other uniquely set information, such as an individual name or an individual symbol, so that the information processing apparatus 105 or the mechanical apparatus 101 can be determined.

The individual numbers 607 can be assigned to the corresponding measured data as follows. First, the information processing apparatus 105 acquires the individual numbers 607 in a new step that is occurs before step S406, S409, or S410 in FIG. 4. Next, in step S410, the information processing apparatus 105 assigns a file name by combining the information about the acquired individual numbers 607 with the determination result in step S407 and the number of times read out in step S409.

According to the present exemplary embodiment, by assigning the individual information as described above to a file name, it is possible to determine from the file name the mechanical apparatus from which the measured data has been acquired or the information processing apparatus that has collected the data. Thus, it is possible to improve the traceability in data analysis work and to execute appropriate data processing. In addition, the present exemplary embodiment can be realized by combining various exemplary embodiments and modifications described above.

Next, a third exemplary embodiment will be described. Hereinafter, the same reference characters will be used for the components that are the same as or equivalent to those in the above-described exemplary embodiments, and the description of these same or equivalent components will be omitted or simplified. That is, the following description will focus on the aspects of the third exemplary embodiment that differ from the above-described exemplary embodiments. In the present exemplary embodiment, when an error occurs in the process, information about the timing of the occurrence of the error is assigned to the file name of corresponding measured data. The information about the timing of the occurrence of the error can be referred to as third information.

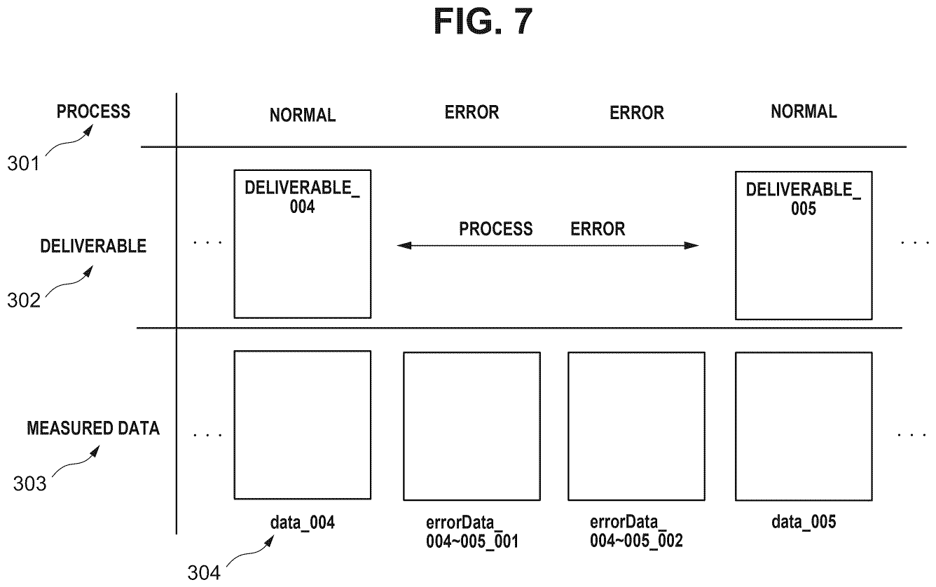

FIG. 7 illustrates a correspondence relationship among the process of the mechanical apparatus 101, deliverables of the mechanical apparatus 101, measured data, and file names according to the present exemplary embodiment. A process 301 indicates whether the process of the mechanical apparatus 101 has been executed normally or whether the process has been interrupted due to an error. The example illustrated in FIG. 7 indicates that the mechanical apparatus 101 has executed the process four times and the four processes have resulted in normal, error, error, and normal in this order.

A deliverable 302 illustrates a deliverable generated (acquired) by a corresponding process 301. Because the second and third processes have been interrupted due to an error during their respective processes, the generated deliverables are those generated by the first and fourth processes. Measured data 303 illustrates the data measured by the measurement sensor 104 during execution of their respective processes. One file of measured data is generated for each process.

A file name 304 is assigned to each of these measured data. The file name 304 includes information regarding whether the process has been executed normally, the cumulative number of normal processes, the cumulative number of error processes, and the timing of the occurrence of the error. The example in FIG. 7 indicates that errors have occurred between the fourth and fifth processes, and the file names of the data corresponding to the processes between the fourth and fifth processes are given “004-005”, which indicates the normal processes executed before and after these errors, of all the cumulative number of normal processes. If the rule is to assign an error process the cumulative number of normal processes before this error process, the error process can be assigned only “004”. If the rule is to assign an error process the cumulative number of normal processes after this error process, the error process can be assigned only “005”. If a running number is to be assigned to each of the processes of the mechanical apparatus 101, then the timing of the occurrence of an error can be indicated by assigning a corresponding cumulative trigger number.

In the present exemplary embodiment, “004” in the file name of the first measured data, which has been normally processed, and “005” in the file name of the fourth measured data, which has been normally processed, are each the cumulative number of processes normally executed. In addition, “001” in the file name of the second measured data, which corresponds to a process interrupted due to an error, and “002” in the file name of the third measured data, which corresponds to a process interrupted due to an error, are each the cumulative number of processes interrupted due to an error. In addition, “004-005” in the second and third measured data indicates that these measured data have been acquired between the first process normally executed and the fourth process normally executed. “data” and “error data” are the same as those according to the above-described first exemplary embodiment.

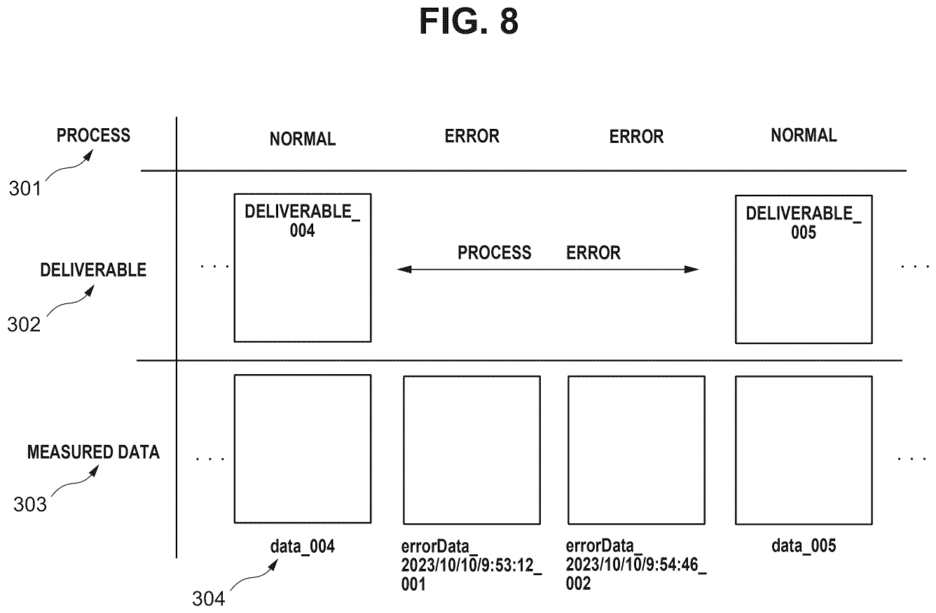

As illustrated in FIG. 8, the information processing apparatus 105 can include a timer, to assign information (time information) about the time of the occurrence of an error to a file name. In the example in FIG. 8, the measured data of the second process is assigned “2023 Oct. 10/9:53:12 (Oct. 10, 2023, 9:53:12)”. In addition, the measured data of the third process is assigned “2023 Oct. 10/9:54:46 (Oct. 10, 2023, 9:54:46)”. Each of these time points can be the start or end timing of the acquisition of corresponding measured data, or can be the timing of a corresponding process interrupted due to an error. By assigning time information to measured data, the timing of the occurrence of an error can be directly determined from the measured data. The start or end timing of the acquisition of all pieces of measured data can be assigned to a corresponding file name.

The timing of the occurrence of an error can be assigned to measured data based on, for example, a normal process. In this case, the number of at least one normal process before and after the error process is read out in step S409 in FIG. 4, and the timing of the occurrence of the error is assigned to the file name of the measured data in step S410. In addition, if the timing of the occurrence of an error is indicated by using the number of all processes of the mechanical apparatus 101, the cumulative number of triggers is read out in step S409, and the timing of the occurrence of the error is assigned to the file name of the target measured data in step S410. In a case where the timing of the occurrence of an error is to be indicated by using time information, a step for reading out the timer information occurs before step S410, and the timing of the occurrence of the error is assigned to the file name of the target measured data in step S410.

As described above, it is possible to set information about the timing of the occurrence of an error to the measured data. This enables determining the timing of the occurrence of the error even after the measured data is converted into a file. If the process is executed normally, a deliverable 302 is obtained from the mechanical apparatus 101. Therefore, by assigning at least one of the above-described cumulative numbers of normal processes to the measured data of a process interrupted due to an error, it is possible to determine the occurrence of the timing of the error from a deliverable.

Next, a fourth exemplary embodiment will be described. Hereinafter, the same reference characters will be used for the components that are the same as or equivalent to those in the above-described exemplary embodiments, and the description of these same or equivalent components will be omitted or simplified. That is, the following description will focus on the aspects of the fourth exemplary embodiment that differ from the above-described exemplary embodiments. Depending on the measurement conditions of the mechanical apparatus 101, a plurality of error determination sensors 109 can be used for determining whether the process of the mechanical apparatus 101 has been executed normally. For example, an acceleration sensor and a current sensor can be used to determine whether the process has been executed normally. In the present exemplary embodiment, a plurality of sensors is used to determine whether the process of the mechanical apparatus 101 is normal or abnormal. If an error occurs, information about which sensor has detected the error is assigned to the measured data. The information about which sensor has detected the error can be referred to as fourth information.

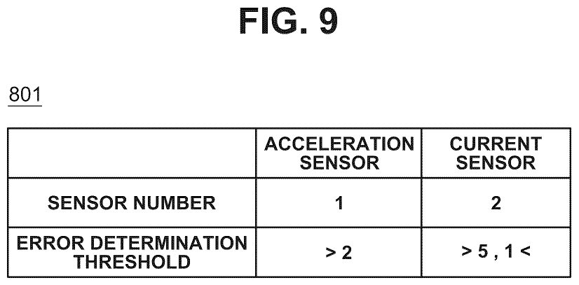

As means for achieving the present exemplary embodiment, a threshold for determining whether the value of a sensor is normal or abnormal can be stored in the storage unit 115 of the information processing apparatus 105. FIG. 9 is a table in which information about sensor numbers and error determination thresholds according to the present exemplary embodiment is set. For example, a table 801 is stored in the storage unit 115 in advance.

In the example illustrated in FIG. 9, if the measured value of an acceleration sensor, which is sensor number 1, is greater than “2” and the measured value of a current sensor, which is sensor number 2, is less than “1” or greater than “5”, these measured values are determined to be outside the respective threshold ranges, and the process of the mechanical apparatus 101 is determined to be an error. The file name assignment unit 113 determines the sensor that has detected the error and the mode of the error, and assigns information about the sensor and the mode to the file name.

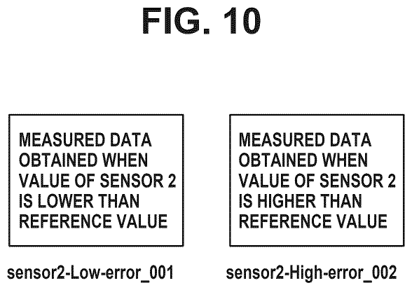

FIG. 10 illustrates a correspondence between measured data and file names according to the present exemplary embodiment. For example, if the value of the current sensor falls below a reference value and the process is interrupted due to the occurrence of this error, the file name assignment unit 113 assigns “sensor2-Low-error_001” as the file name of the measured data. “sensor2-Low-error” indicates that the value of the current sensor is lower than the reference value and results in an error. If the value of the current sensor exceeds a reference value and the process is interrupted due to the occurrence of this error, the file name assignment unit 113 assigns “sensor2-High-error_002” as the file name of the measured data. “sensor2-High-error” indicates that the value of the current sensor is higher than the reference value and results in an error. “001” and “002” are the same as those according to the above-described exemplary embodiments.

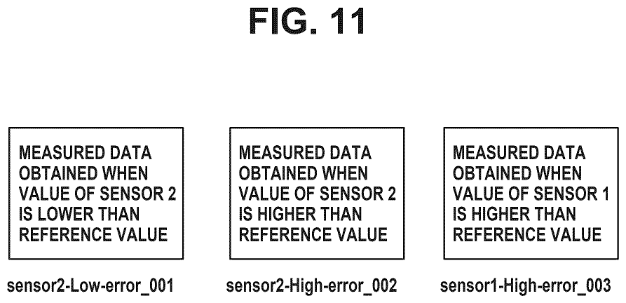

In a case, for example, where the measured value of the acceleration sensor having sensor number 1 is greater than “2” or the measured value of the current sensor having sensor number 2 is less than “1” or is greater than “5”, if the process of the mechanical apparatus 101 is determined as an error due to the measured values of the acceleration sensor and the current sensor being outside their respective threshold ranges, a file name as illustrated in FIG. 11 can be assigned. For example, if the value of the acceleration sensor exceeds the reference value and the process is interrupted due to the occurrence of the error, the file name assignment unit 113 assigns “sensor1-High-error_003” as the file name of the measured data. “sensor1-High-error” indicates that the value of the acceleration sensor is over the reference value and results in an error. “003” is the same as that according to the above-described exemplary embodiments. In addition, “acceleration sensor” can be assigned as “sensor1” and “current sensor” can be assigned as “sensor2” to the file name.

The sensor name can be assigned to measure data as follows. First, in a new step that occurs before step S410, the information processing apparatus 105 acquires, based on the target measured data, the name of the sensor that has acquired the measured data from the storage unit 115. Next, in step S410, the information processing apparatus 105 assigns a file name by combining the information about the acquired sensor name with the determination result in step S407 and the number of times read out in step S409. As a result, even after measured values have been converted into a file, it is possible to determine the sensor that corresponds to a part of the machine apparatus has detected an error, and therefore, an abnormal part can be detected at an early stage. This enables improving the traceability in data analysis work and executing appropriate data processing. In addition, the present exemplary embodiment can be realized by combining various exemplary embodiments and modifications described above.

The present disclosure is not limited to the exemplary embodiments and examples described above, and many modifications are possible within the technical concept of the present disclosure. For example, it is possible to carry out the present disclosure by combining all or some of the above-described different exemplary embodiments and examples. In addition, as the mechanical apparatus, it is possible to use a vertical or horizontal articulated robot having multiple joints, a parallel link robot, an orthogonal robot, or the like. In addition, as the mechanical apparatus, it is possible to use a machine that can automatically execute extension, bending and stretching, vertical movement, horizontal movement, turning, or a combination of these movements, based on information in a storage device provided in a control device.

The procedure of the process of any one of the above-described exemplary embodiments is executed by various functional blocks based on a CPU and by instructions inputted by a user. That is, the procedure can be executed by reading out a software program that can execute the above-described functions from a storage medium.

In this case, the program itself that is read out from the storage medium realizes the functions of any one of the above-described exemplary embodiments, and the program itself and the storage medium storing the program constitute a corresponding exemplary embodiment of the present disclosure. In addition, a printer configured to execute a software program that can execute the above-described functions, and a method for controlling the printer also constitute a corresponding exemplary embodiment of the present disclosure.

In the exemplary embodiments, a computer-readable storage medium is a ROM, a RAM, or a flash ROM, and a control program is stored in the ROM, RAM, or flash ROM. The present disclosure is not limited to these exemplary embodiments. The program for carrying out an exemplary embodiment of the present disclosure can be recorded on any storage medium that is readable by a computer. A solid-state drive (SSD) can be used as the storage unit.

In the various above-described exemplary embodiments, the error determination sensor 109 is provided in addition to the measurement sensor 104 for acquiring measured data. However, error determination can be executed by just using the measurement sensor 104. For example, thresholds for determining whether the measured data obtained by the measurement sensor 104 is erroneous are set. If the measured data falls within this threshold range, it is determined that the process has been executed normally. If any of the measured data does not fall within this threshold range, it may be determined that an error has occurred. As another threshold for determining an error, for example, a reference time period can be set. If measured data has been outside the threshold over this reference time period, an error can be determined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

This application claims the benefit of Japanese Patent Application No. 2023-183965, filed Oct. 26, 2023, which is hereby incorporated by reference herein in its entirety.

What is claimed is:

1. An information processing apparatus configured to acquire information about an apparatus that executes a predetermined process, the information processing apparatus comprising:
at least one memory storing at least one program; and
at least one processor, that when executing the at least one program, causes the information processing apparatus to:
assign first information about success or failure of the execution of the predetermined process; and
assign second information about an execution timing of the predetermined process to data that changes depending on a state of the apparatus.

2. The information processing apparatus according to claim 1, wherein the information processing apparatus assigns identification information about the apparatus and/or identification information about the information processing apparatus to the data.

3. The information processing apparatus according to claim 1, wherein the information processing apparatus assigns, as the first information, an execution timing at which the predetermined process has been normally executed or an execution timing at which the predetermined process has been interrupted due to an error.

4. The information processing apparatus according to claim 3,
wherein the information processing apparatus separately acquires the execution timing at which the predetermined process has been normally executed and the execution timing at which the predetermined process has been interrupted due to an error, and
wherein the information processing apparatus assigns the execution timing at which the predetermined process has been normally executed to data obtained when the predetermined process has been normally executed, and assigns the execution timing at which the predetermined process has been interrupted due to the error to the data obtained when the predetermined process has been interrupted due to the error.

5. The information processing apparatus according to claim 3, wherein the information processing apparatus assigns third information about a timing of occurrence of the error to the data.

6. The information processing apparatus according to claim 5, wherein the information processing apparatus assigns, as the third information, at least one of the execution timing of the predetermined process executed normally before or after the predetermined process in which the error has occurred.

7. The information processing apparatus according to claim 5, wherein the information processing apparatus assigns, as the third information, time information about the execution of the predetermined process in which the error has occurred.

8. The information processing apparatus according to claim 3, wherein the information processing apparatus determines the error based on a value of a first sensor for determining an error.

9. The information processing apparatus according to claim 8, wherein the information processing apparatus assigns fourth information about the first sensor that has outputted a value determined to be the error to the data.

10. The information processing apparatus according to claim 9, wherein the information processing apparatus assigns, as the fourth information, information regarding whether the value determined to be the error is greater than or less than a corresponding threshold range.

11. The information processing apparatus according to claim 8, wherein the information processing apparatus stores the value of the first sensor without processing the value or stores the value of the first sensor after executing at least one of an average value process, a maximum value process, a minimum value process, or a fast Fourier transform (FFT) process on the value.

12. The information processing apparatus according to claim 8, wherein the information processing apparatus determines the error based on a value of a second sensor for acquiring the data.

13. The information processing apparatus according to claim 12, wherein the second sensor is at least one of an acceleration sensor, an electric current sensor, a position sensor, a vibration sensor, a force sensor, a camera, a pressure sensor, a light sensor, a torque sensor, or a temperature sensor.

14. The information processing apparatus according to claim 1, wherein the information processing apparatus assigns the first information and the second information to the data as a file name.

15. The information processing apparatus according to claim 1, wherein the apparatus is a printer.

16. The information processing apparatus according to claim 1, wherein the apparatus is a grinder, a polisher, a molding machine, or a robot.

17. An article manufacturing method, comprising:
acquiring a state of an apparatus using an information processing apparatus, the information processing apparatus comprising:
at least one memory storing at least one program; and
at least one processor, that when executing the at least one program, causes the information processing apparatus to:
assign first information about success or failure of the execution of the predetermined process; and
assign second information about an execution timing of the predetermined process to data that changes depending on a state of the apparatus, and
manufacturing an article using the apparatus.

18. An information processing method for acquiring information about an apparatus configured to execute a predetermined process, the information processing method comprising:
assigning first information about success or failure of the execution of the predetermined process; and
assigning second information about an execution timing of the predetermined process to data that changes depending on a state of the apparatus.

19. A printer configured to execute a printing process, wherein the printer comprises:
at least one memory storing at least one program; and
at least one processor, that when executing the at least one program, causes the printer to:
assign first information about success or failure of the execution of the printing process; and
assign second information about an execution timing of the printing process to data that changes depending on a state of the printer.

20. A method for a printer configured to execute a printing process, the method comprising:
assigning first information about success or failure of the execution of the printing process; and
assigning second information about an execution timing of the printing process to data that changes depending on a state of the printer.

21. A computer-readable storage medium storing a program for causing a computer to execute the control method according to claim 20.
